(19) United States
(12) Patent Application Publication
(10) Pub. No.: US 2006/0182587 A1
(43) Pub. Date: Aug. 17, 2006

(54) Lifting tool

(76) Inventor: Steven J. Hrkal, Hamel, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/320,076

(22) Filed: Dec. 28, 2005

Related U.S. Application Data
(60) Provisional application No. 60/640,165, filed on Dec. 29, 2004.
(60) Provisional application No. 60/678,409, filed on May 6, 2005.

(51) Int. Cl. B65G 47/90

(52) U.S. Cl. 414/626

(57) ABSTRACT

The multi-use lifting tool includes a pair of pivotally connected crossbeams; an engagement plate engaged to each crossbeam; a traverse element engaged to each crossbeam opposite to the engagement plates; and a central lifting member which may include a swivel engaged to the traverse element approximately equal distances between the crossbeams. The elevation of the central lifting member draws the engagement plates together to grasp and hold a heavy object used in landscaping or construction. Transport of the object may then be initiated.

### CROSS-REFERENCE TO RELATED APPLICATIONS

This application claims priority to U.S. Provisional Application No. 60/640,165, filed Dec. 29, 2004, and U.S. Provisional Application No. 60/678,409 filed May 6, 2005, the entire contents of which are incorporated herein in their entireties.

### BACKGROUND OF THE INVENTION

In the past, lifting and transport of cut stone, blocks, pipe and/or boulders during construction activities was quite difficult. Generally, heavy landscaping materials were carried in the bucket of a front-end or skid loader for delivery to a desired location within a worksite. The loading of heavy landscaping materials into a bucket of a front-end loader frequently resulted in damage to the materials, necessitating replacement and causing waste of physical and economical resources.

In the past, heavy landscaping materials transported in the bucket of a front-end or skid loader regularly became damaged during the deposit of the materials at a desired location. The weight of the transported materials frequently necessitated that the materials be dumped out of the bucket, which in turn, caused damage to the articles.

In the past, the bucket and/or teeth of a bucket, were used to push heavy landscaping materials into a desired location. The teeth and/or bucket of a front-end or skid loader often damaged the landscaping materials during pushing and/or relocation.

A need therefore exists for a device to transport heavy construction materials such as cut stone, block, pipe and/or boulders which minimizes damage to the landscaping materials during transportation.

In the past, the weight of certain landscaping materials rendered manual transportation impossible. Frequently, each piece of cut stone, block, pipe or boulder may have weighed as much as 1,000 pounds. Therefore, a need exists for a lifting device which significantly reduces the manual labor required to move heavy landscaping materials during construction activities. A need also exists for a device which may be quickly and conveniently attached to a skid or front-end loader for transporting heavy landscaping materials which maximizes safety considerations.

In the past, a number safety concerns arose during the transportation of heavy landscaping materials within the bucket of a front-end or skid loader. Frequently, the bucket and/or skid loader became overloaded with materials, which increased the risk that one or more of the materials would fall out of the bucket or injure an individual.

In the past, the use of a skid or front-end loader to transport heavy construction materials did not facilitate the exact positioning or alignment of a particular object during construction activities. A need therefore exists for a lifting device which includes a swivel coupler to enable rotation of a transported landscaping object for exact placement during construction activities.

### BRIEF SUMMARY OF THE INVENTION

In general, the lifting tool is formed of a pair of pivotally connected crossbeams. Each crossbeam preferably includes a first end and a second end. An engagement plate is connected to each of the first ends. A traverse element extends between the second ends of the crossbeam opposite to the engagement plates. A center lifting member is generally engaged to the traverse element approximately equal distances between the crossbeams. The central lifting member, when elevated, draws the engagement plates together to grasp and lift an object to be transported.

In some embodiments, the crossbeams are tubular and are formed of metal material. In at least one embodiment, the traverse element is formed of either a chain or cable.

In some embodiments, the central lifting member includes a swivel to facilitate the rotational orientation of an object lifted between the engagement plates. In at least one embodiment, the first ends of the crossbeam are formed as adaptors in a manner similar to a trailer hitch adaptor and receiver.

In some embodiments, the engagement plates are attached to receivers which in turn are constructed for coupling to the adaptors of the crossbeams. In at least one embodiment the engagement plates are substantially flat, or arcuate, to either lift an object having a flat or curved profile. In some embodiments, the engagement plates include a face having a resilient and flexible surface. In at least one embodiment, a handle is affixed to at least one crossbeam. In some embodiments, at least one of the crossbeams includes a centrally disposed receiving slot where the other crossbeam is positioned internally within the centrally disposed receiving slot.

In at least one embodiment, the engagement plates are angularly offset relative to the crossbeam and/or receiver to facilitate the lifting of an object. In some embodiments the second ends of the crossbeam include a slot which releasably receives a portion of the traverse element. In at least one embodiment, the crossbeams are formed of more than one section connected to each other.

### BRIEF DESCRIPTION OF THE SEVERAL VIEWS OF THE DRAWING(S)

FIG. 1 is an environmental, isometric, partial phantom line view of the lifting tool.

FIG. 2 is an alternative environmental and isometric view of the lifting tool.

FIG. 3 is an alternative partial detail view of the lifting tool.

FIG. 4 is an alternative environmental view of the lifting tool.

FIG. 5 is an alternative partial detail view of the lifting tool.

FIG. 6 is an alternative detail view of the second end of a crossbeam.

FIG. 7 is an alternative detail view of the second end of a crossbeam.

### DETAILED DESCRIPTION OF THE INVENTION

While this invention may be embodied in many different forms, there are described herein alternative embodiments of the invention. This description is an exemplification of the principles of the invention and is not intended to limit the invention to any particular embodiments illustrated.

For the purposes of this disclosure, like reference numerals in the figures shall refer to like features unless otherwise indicated.

In at least one embodiment, the lifting tool 10 is formed of a pair of crossbeams 12 which are pivotally attached to each other. The crossbeams 12 may be formed of tubular metal material, may be solid, may be I-shaped, and/or cylindrical at the discretion of an individual.

In some embodiments, the crossbeams 12 are pivotally engaged to each other through the use of a pivot pin. In one embodiment, one crossbeam 12 may include a centrally disposed slot 34. The slot 34 may be formed as the space between a first beam section 38 and a second beam section 40, as connected to each other through the use of a pair of connection plates 42. In at least one embodiment, the connection plates 42 are welded to the exterior surface of the first and second beam sections 38, 40 respectively. In some embodiments, the centrally disposed slot 34 is the area interior to the connection plates 42 and above and below the second beam section 40 and the first beam section 38 respectively.

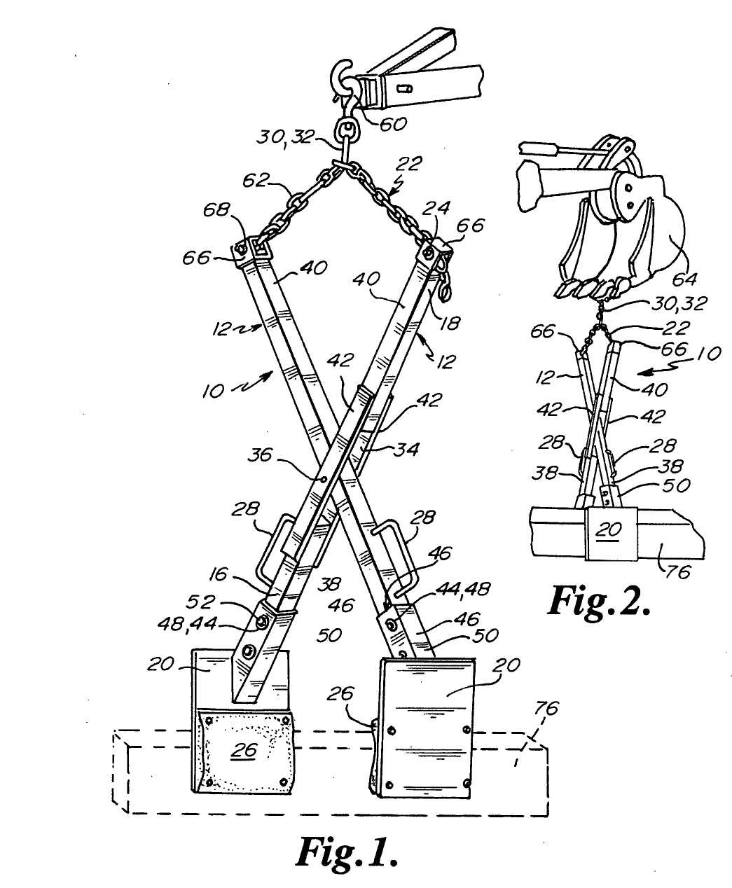

In some embodiments the second crossbeam 12 may be an integral one piece section. In at least one embodiment, the second crossbeam 12 is positioned within the receiving slot 34 located within the interior of the first crossbeam. (FIGS. 1 and 2)

In some embodiments, the crossbeams 12 may be positioned side by side. Each crossbeam 12 preferably includes an aligned aperture adapted for receiving engagement of a bolt 36 or pin, to pivotally connect the crossbeams 12 together. In some embodiments, the crossbeams 12 are engaged to each other to form the shape of an X.

In some embodiments, each of the crossbeams 12 include a first end 16 and a second end 18. An engagement plate 20 is preferably affixed or connected to each of the first ends 16. In some embodiments, the engagement plates 20 are angularly offset relative to the crossbeams 12, at an angle of approximately 40°. In at least one embodiment, the engagement plates 20 are angularly offset relative to the tubular receiver 50 by an angle of approximately 40°.

In some embodiments, the engagement plates 20 may be permanently attached to the first end 16 of the crossbeams 12. In other embodiments, the engagement plates 20 may be releasably coupled to the first ends 16 of the crossbeams 12. In at least one alternative embodiment, the engagement plates 20 may be welded to the receiver 50 which receives the adaptor 46 in a manner similar to a standard trailer hitch. In some embodiments, the engagement plates 20 may be bolted to the first ends 16 of the crossbeams 12 and in other embodiments, the engagement plates 20 may be welded to the first ends 16 of the crossbeams 12.

In at least one embodiment, the first ends 16 of the crossbeams 12 are constructed of a standard two inch tubular metal material as may be found within a standard trailer hitch receiver for a motor vehicle. The first ends 16 of the crossbeams 12 therefore define the size of the receiver 50. In at least one embodiment, the first ends 16 of the crossbeams 12 include at least one aperture 44. In some embodiments, the engagement plates 20 include a receiver 50 having at least one aperture 48 constructed for alignment with the apertures 44 of the crossbeams 12. The tubular receiver 50 is preferably constructed and sized for coupling to, the adaptor 46.

In some embodiments, the engagement plates 20 may be interchanged with different shaped engagement plates 20 by manipulation and retraction of a pin or bolt 52 to transport a different shaped object such as a boulder 54 or pipe 56. In some embodiments, the use of the adapter 46 and the receiver 50 enables the engagement plates 20 to be easily and conveniently interchanged for use in the transport of alternatively shaped and/or sized objects 76.

In some embodiments, each of the engagement plates 20 includes a resilient and/or flexible rubber face 26 which is adapted for contact with an object 76 to be lifted such as a block of stone. The rubber face 26 preferably minimizes scratching and/or damage to an object 76 to be lifted by the lifting tool 10. In some embodiments, the rubber face 26 may be attached to the engagement plates 20 through the use of bolts and nuts, adhesive, and/or any other desired affixation mechanism for either releasable and/or permanent attachment thereto. In some embodiments, the rubber face 26 of the engagement plates 20 may include a texture to assist in the minimization of slipping of a grasped object to be transported.

In at least one embodiment, the angle of the engagement plates 20 relative to the first ends 16 of the crossbeams 12, or the receiver 50, in conjunction with the use of the rubber face 26, facilitates flush engagement of the engagement plates 20 to the flat sides of an object such as a block, a cut stone, or step, as well as the curved surface of a pipe or boulder. In some embodiments, the rubber face 26, in combination with the angled engagement plates 20, securely grasps either an object 76 having flat sides or a curved exterior surface without slipping or dropping of the object 76 during landscaping or construction activities.

In at least one embodiment, each of the crossbeams 12 proximate to the engagement plates 20 may include a handle 28. Each handle 28 may be attached to a crossbeam 12 through the use of welding and/or any other desired affixation mechanism such as bolts and nuts.

In some embodiments, lifting tool 10 includes a single handle 28. In some embodiments, two or more handle(s) 28 may be used to transport the lifting tool 10 between jobsites or may be used to facilitate the substitution of alternatively shaped engagement plates 20 to the crossbeams 12.

In some embodiments, opposite to the engagement plates 20, and adjacent to the second ends 18 of the crossbeams 12, is located a traverse element 22, which may be a chain and/or cable. The traverse element 22 preferably extends between the second ends 18 of the crossbeams 12. In at least one embodiment, the traverse element 22 may be either permanently or releasably engaged to the second ends 18 of the crossbeams 12 through the use of either a clevis, a bolt and pin, and/or may be welded thereto. The traverse element 22 is preferably adjustable in length relative to the crossbeams 12.

In some embodiments, the ends 18 of the crossbeams 12 include a traverse bracket 66. The traverse bracket 66 is preferably tubular and may be welded to the ends 18 of the crossbeams 12. The traverse brackets 66, in some embodiments, include a pair of aligned bracket apertures 68 which in turn are adapted to releasably receive a pin or bolt 24. The pin or bolt 24 is preferably used to releasably secure the traverse element 22 to the ends 18 of the crossbeams 12.

In some embodiments, the releasable attachment of the traverse element 22 to the ends 18 of the crossbeams 12 enables an individual to adjust the length of the traverse element 22 depending upon the width of the object to be lifted. In some embodiments, the traverse element 22 may be a chain 62 where the pin and/or bolt 24 pass through a link in the chain 62. In alternative embodiments, a cable may be used where the ends of the cable are looped and affixed together through the use of a cable tie. The pin and/or bolt 24 may then pass through the loop to releasably couple the traverse element to the crossbeams 12.

In some embodiments, the ends 18 of the crossbeams 12 include a central slot 70. The width of the central slot 70 is preferably sufficient to receive the traverse element 22. In at least one embodiment, the ends 18 of the crossbeams 12 include aligned apertures 68 which traverse the central slot 70. The aligned apertures 68 are preferably adapted to receive a pin and/or bolt 24 to couple the traverse element 22 to the crossbeams 12.

In at least one embodiment, the ends 18 of the crossbeams 12 are not altered and may be formed of tubular metal. In this embodiment, aligned apertures 68 may be placed through the ends 18. The traverse element 22 may then be positioned either to the interior of the crossbeam 12, or to the exterior of the crossbeam 12 proximate to the aligned apertures 68. A pin or bolt 24 may then be used to releasably attach the traverse element 22 to the interior or exterior of the ends 18 of the crossbeams 12.

In some embodiments, the lifting tool 10 further includes a central elevation and/or lifting member 30 which is engaged to the traverse element 22 approximately equal distances between the ends 18 of the crossbeams 12. The central lifting member 30 may be pivotally connected to the traverse element 22, chain, and/or cable or securely attached thereto. In some embodiments, an elevation chain and/or cable 32 may be engaged to the central lifting member 30. In turn, the elevation chain/cable 32 may be engaged to a machine such as a backhoe bucket, skid loader bucket, front-end loader bucket, and/or other lifting machinery 64.

In some embodiments, the lifting member 30 may be releasably attached to the traverse element 22. In alternative embodiments, the lifting member 30 may be integrally connected to the traverse element 22. In some embodiments, the lifting member 30 may be a section or portion of the traverse element 22. The lifting member 30 may be of the same or different material as the traverse element 22 such as a chain or cable.

In one embodiment, the lifting member 30 may include a carabineer and/or a hook including a swivel 60. In this embodiment, the carabineer may also be releasably coupled to a link of chain 62 of the traverse element 22. In alternative embodiments, a swivel hook 60 may be welded or fixedly attached to the traverse element 22. In some embodiments, the swivel hook 60 may include a loop which is adapted to slidably receive a cable used as the traverse element 22. In some embodiments, the swivel hook 60 may slide along the traverse element 22 prior to elevation by a machine or bucket 64.

In some embodiments, a grade 8 and ¾ inch hinge bolt is used to pivotally attach each of the crossbeams 12 together. The hinge bolt may be inserted within a central sleeve or bushing at the discretion of an individual.

In some embodiments, the first ends 16 of the crossbeams 12 may be constructed to facilitate the substitution of different shapes and/or sizes of engagement plates 20, which may be rectangular, square, and/or have a curved interior surface for the grasping and elevation of construction materials having rounded or non-regularly shaped sides. The use of a universally sized receiver 50 for coupling with an adaptor 46 of a crossbeam 12 enables an operator to quickly and easily substitute engagement plates 20, to lift and transport a specific type of object. For example, an engagement plate 20 may be arcuate and adapted for lifting of boulders or pipes. In at least one embodiment, the bolts and/or pins 52 used to couple the engagement plate 20 to the cross beams 12 are quick release pins facilitating the replacement of a desired type of engagement plate 20 for transport of an object. In at least one embodiment, the pins 52 include apertures adapted for receipt of cotter pins.

In some embodiments, the lifting tool 10 is designed for elevation and transportation of objects having an 18 to 24 inch width dimension. In other embodiments, lifting tool 10 may transport objects having a width dimension in excess of 24 inches and less than 18 inches. In some embodiments lifting tool 10 may also be used to transport objects other than materials for construction and/or landscaping.

In at least one embodiment as seen in FIGS. 6 and 7, the second ends 18 of cross beams 12 may include a central slot 70 through one set of opposite faces; and may also include aligned apertures 68 through the pair of two perpendicular faces. A link of chains 62 may be inserted within the central slot 70 whereupon a bolt or pin 24 may pass through the aperture 68, through the link chain 62, and then through the opposite aperture 68 for receipt of a nut and/or cotter pin to releasably attach an end of the traverse element 22 to the second end 18 of the cross beam 12.

In at least one embodiment, the cross beams 12 may be formed of two or more cross beam sections 38, 40 which are releasably coupled directly to each other, without the use of connecting plates 42. In this embodiment, one end of a cross beam section 38 may include an adaptor 46 for insertion within a receiver 50 of one end of the other cross beam section 40. A pin or bolt may be used to releasably engage two or more cross beam sections 38, 40 directly to each other. In some embodiments, the provision of two or more cross beam sections 38, 40 for each cross beam element 12 facilitates the disassembly and transportation between job sites, improving the overall utility of the lifting tool 10.

In some embodiments, lifting tool 10 may be engaged to a swivel hook 60 as attached to a machine 64. (FIG. 1) In alternative embodiments, lifting tool 10 may be engaged to a bucket 64 of a backhoe. (FIG. 2)

In at least one embodiment, the swivel hook 60 enables 360° rotation of a suspended object to facilitate exact placement of materials within a job site. In some embodiments, the lifting cable/chain 32 in association with a swivel hook 60 affords to a workman improved side to side and/or back to front control of a transported object for placement at a precise location within a work cite. In some embodiments, the provision of a swivel hook 60 facilitates the rotational positioning and orientation of a transported object immediately prior to final placement at a construction and/or landscaping cite. The swivel hook 60 and/or the lifting chains/cable 32 enables an individual to easily rotate an object as suspended by the lifting tool 10 immediately prior to instillation.

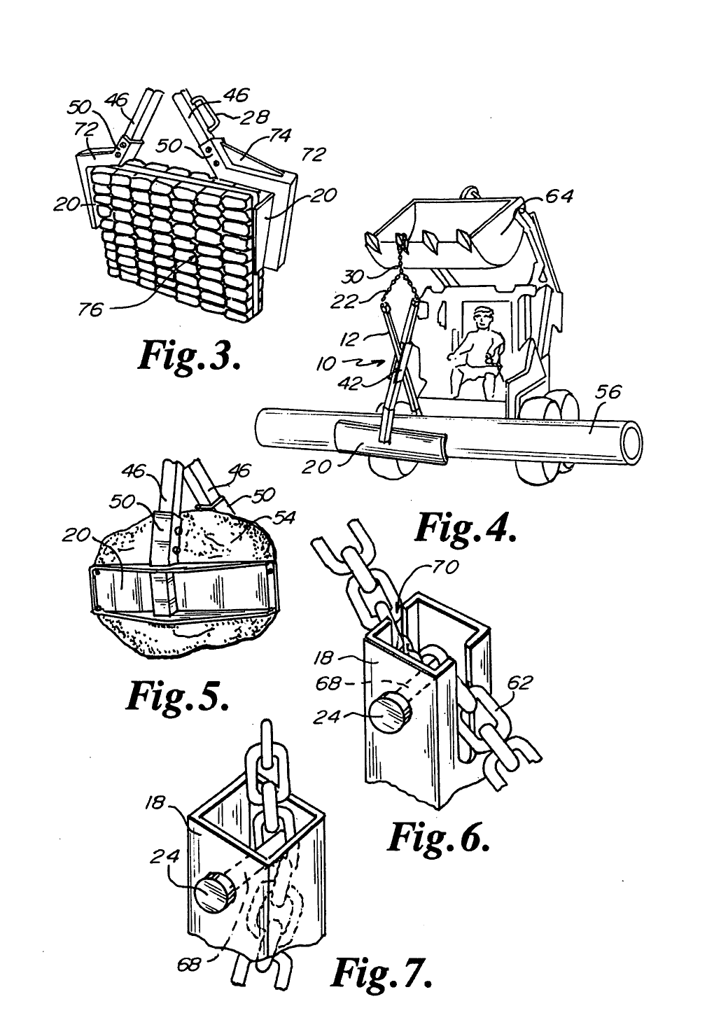

In some embodiments, the engagement plates 20 may include elongated faces 26 to transport stacks of bound items such as bricks. (FIG. 3) In at least one embodiment, the engagement plates 20 may include an extension 72 between the receiver 50 and the face 26. In some embodiments, a brace 74 may be engaged to the extensions 72 to enhance structural support.

In some embodiments, as depicted in FIG. 5 the engagement plates 20 may have angled faces 26 which are adapted to receive a round or partially spheroid object such as a bolder 54. (FIG. 5) In some embodiments, the engagement plates 20 may include a regular arcuate face 26 adapted for receipt of a substantially cylindrical object such as a pipe 56 or timber. (FIG. 4)

In some embodiments, the lifting tool 10 is constructed to transport objects weighing approximately 1,000 pounds. In alternative embodiments, the lifting tool 10 is constructed to transport objects weighing more or less than 1,000 pounds.

In at least one embodiment, the lifting tool 10 shifts the weight burden from beneath an object to the sides of an object during transportation. In some embodiments, the lifting tool 10 eliminates the need for affixation straps for transport of an object. In at least one embodiment, an affixation strap may be used in conjunction with the lifting tool 10. In some embodiments, the lifting tool 10 eliminates the need for shovels, crowbars, and/or 2×4's for lifting and placement of an object.

In some embodiments, the lifting tool 10 reduces the time required for transport and positioning of construction and/or landscaping materials.

During use, the engagement plates 20 are adapted for positioning on either side of an object to be lifted such as a block of stone, cut stone, step, boulder, timber, pipe and/or other heavy item. The machine/engine 34 then elevates the lifting chain/cable 32 and the central lifting member 30 which causes the vertical elevation of the traverse element 22 at a central point. The elevation of the traverse element 22 draws the second ends 18 of the crossbeams together which, in turn, causes the engagement plates 20 to exert pressure and to grasp the object to be lifted. The continued elevation of the central lifting member 30 causes an increased pressure to be exerted by the engagement plates 20 against the side of the object, and the elevation and/or lifting of the object for transportation to a desired location.

Generally, the lifting tool 10 is used for transporting heavy objects such as steps, cut stone, boulders, and/or timber, or beams or railroad ties for landscaping purposes.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims. The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below (e.g. Claim 3 may be taken as alternatively dependent from claim 2; claim 4 may be taken as alternatively dependent on claim 2, or on claim 3; claim 6 may be taken as alternatively dependent from claim 5; etc.). Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below (e.g. Claim 3 may be taken as alternatively dependent from claim 2; claim 4 may be taken as alternatively dependent on claim 2, or on claim 3; claim 6 may be taken as alternatively dependent from claim 5; etc.).

This completes the description of the preferred and alternate embodiments of the invention. Those skilled in the art may recognize other equivalents to the specific embodiment described herein which equivalents are intended to be encompassed by the claims attached hereto.

1. A lifting tool comprising:
a) a pair of pivotally connected crossbeams, each of said crossbeams having an engagement plate;
b) a traverse element engaged to said crossbeams opposite to said engagement plate; and
c) a central lifting member engaged to said traverse element approximately equal distances between said crossbeams, said central lifting member being constructed and arranged to draw said engagement plates toward each other during elevation of said traverse element.

2. The lifting tool according to claim 1, wherein said crossbeams are tubular.

3. The lifting tool according to claim 1, said traverse element comprising a chain.

4. The lifting tool according to claim 1, said traverse element comprising a cable.

5. The lifting tool according to claim 1, said lifting member comprising a swivel.

6. The lifting tool according to claim 1, each of said crossbeams comprising a first end and a second end.

7. The lifting tool according to claim 6, said first ends comprising an adaptor.

8. The lifting tool according to claim 7, further comprising said engagement plates connected to an adapter, said adapter being constructed and arranged for coupling to said adaptor.

9. The lifting tool according to claim 1, wherein said engagement plate is substantially flat.

10. The lifting tool according to claim 1, wherein said engagement plate is substantially rectangular.

11. The lifting tool according to claim 1, wherein said engagement plate is substantially arcuate.

12. The lifting tool according to claim 1, said engagement plate comprising a face having a resilient and flexible surface.

13. The lifting tool according to claim 1, further comprising a handle engaged to at least one of said crossbeams.

14. The lifting tool according to claim 1, one of said crossbeams comprising a receiving slot and said other crossbeam being positioned within said receiving slot.

15. The lifting tool according to claim 1, wherein said engagement plate is angularly offset relative to said crossbeam.

16. The lifting tool according to claim 8, wherein said engagement plate is angularly offset relative to a receiver.

17. The lifting tool according to claim 1, wherein said traverse element is releasably engaged to said crossbeams.

18. The lifting tool according to claim 6, said second ends comprising a slot constructed and arranged to releasably receive said traverse element.

19. The lifting tool according to claim 1, said each of said crossbeams comprising at least one section.

20. The lifting tool according to claim 1, said each of said crossbeams comprising at least two sections.
